(19) United States
(12) Patent Application Publication
(10) Pub. No.: US 2004/0061621 A1
(43) Pub. Date: Apr. 1, 2004

(54) Remote control system

(75) Inventor: Muneki Ishida, Tokyo (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/664,689

(22) Filed: Sep. 18, 2003

(30) Foreign Application Priority Data
Sep. 27, 2002 (JP) 2002-283507

(51) Int. Cl. G08C 19/00

(52) U.S. Cl. 340/825.72; 340/825.69; 348/734; 345/169

(57) ABSTRACT

A remote control system includes a remote control apparatus which stores software programs for driving different kinds of devices capable of wireless communication and which recognizes the devices when the devices are positioned within a set range. The remote control apparatus includes a monitor for displaying information of one or more of the devices which are being recognized and a controller for controlling the devices and the monitor. Accordingly, a plurality of devices can be easily controlled.

### BACKGROUND OF THE INVENTION

1. Field of the Invention

The present invention relates to remote control systems for controlling devices such as mobile devices, and more specifically relates to a remote control system which recognizes and controls devices.

2. Description of the Related Art

Remote control systems having a rotating wheel rotated for controlling devices are known in the art.

Such a system is described in, for example, Column 3 and FIG. 1 of U.S. Pat. No. 5,381,080, and Columns 4 and 5 and FIG. 1 of U.S. Pat. No. 6,128,006.

When devices are controlled by rotating a rotating wheel as described above, various controls can be performed while obtaining various kinds of operational feel simply by operating the rotating wheel. Accordingly, the devices can be easily controlled.

However, according to the U.S. Pat. No. 5,381,080, a controlled device and a remote control system are connected to each other with a bus line, and the remote control system cannot control different kinds of devices.

On the other hand, various mobile devices such as notebook computers, camcorders, digital cameras, personal digital assistants (PDAs), and mobile phones have recently been developed.

When devices including the mobile devices are located in a specific place such as a house or a vehicle, it is convenient if the devices can be controlled with a single remote control system since it is not necessary to use a plurality of remote control systems in such a case.

### SUMMARY OF THE INVENTION

Accordingly, an object of the present invention is to provide a remote control system with which a plurality of devices can be easily controlled.

In order to achieve this object, according to the present invention, a remote control system includes a remote control apparatus which stores software programs for driving different kinds of devices capable of wireless communication and which recognizes the devices when the devices are positioned within a set range, and the remote control apparatus includes a monitor for displaying information of one or more of the devices which are being recognized and a controller for controlling the devices and the monitor. According to this construction, the remote control apparatus recognizes the devices when they are positioned within the set range and controls them using the software programs corresponding to the devices.

The remote control apparatus may further include a controlled-device selector for selecting a device to be controlled when two or more of the devices are recognized. According to this construction, when two or more of the devices are simultaneously recognized by the remote control apparatus, a device to be controlled can be selected from among the recognized devices.

In addition, the monitor may be built-in in the remote control apparatus. According to this construction, a user can control the device while viewing the built-in monitor.

Alternatively, the monitor may be disposed separately from the remote control apparatus, and information may be communicated between the remote control apparatus and the monitor by wireless communication. According to this construction, the user can control the device while viewing the monitor disposed at a desired position.

The remote control system may further include a printer for recording the information of the devices. According to this construction, the information of the devices can be recorded and output.

The controller may be a rotation controller having a rotating wheel for operation. According to this construction, a predetermined operation can be easily performed simply by rotating the rotating wheel.

Although the present invention will be clearly explained in the following description of the preferred embodiment, the present invention is not limited to the disclosed embodiment.

### BRIEF DESCRIPTION OF THE DRAWINGS

FIG. 1 is a schematic perspective view of a remote control system according to an embodiment of the present invention; and

FIG. 2 is a block diagram showing the internal construction of a remote control apparatus shown in FIG. 1, where a part of the construction is different from that shown in FIG. 1.

### DESCRIPTION OF THE PREFERRED EMBODIMENT

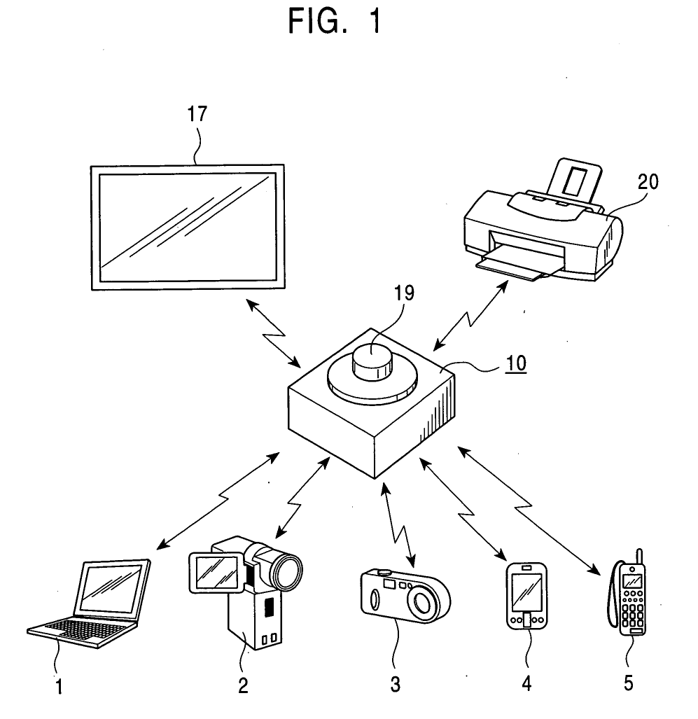

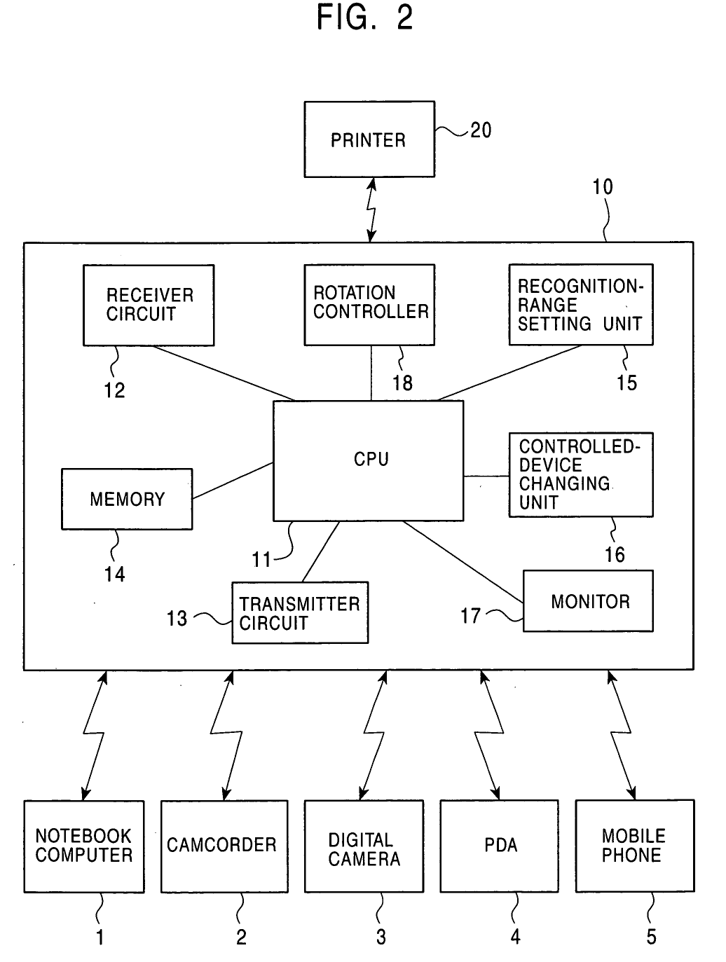

FIGS. 1 and 2 show a remote control system according to an embodiment of the present invention.

With reference to FIG. 1, a remote control apparatus 10 is driven by a power supply (not shown) and performs two-way communication with mobile devices including a notebook computer 1, a camcorder 2, a digital camera 3, a personal digital assistant (PDA) 4, and a mobile phone 5, by wireless communication.

Accordingly, as shown in FIG. 2, the remote control apparatus 10 includes a central processing unit (CPU) 11 and a receiver circuit 12 and a transmitter circuit 13 which are connected to the CPU 11. Although not shown in the figure, each of the notebook computer 1, the camcorder 2, the digital camera 3, the PDA 4, and the mobile phone 5, of course, also has a receiver circuit and a transmitter circuit. The CPU 11 of the remote control apparatus 10 has a memory 14 including a random access memory (RAM), a read-only memory (ROM), etc., and software programs for driving each of the devices including the notebook computer 1, the camcorder 2, the digital camera 3, the PDA 4, the mobile phone 5, and other devices are installed in advance in the memory 14.

In addition, the remote control apparatus 10 further includes a recognition-range setting unit 15 which is connected to the CPU 11. The recognition-range setting unit 15 is used for setting a recognition range within which the devices such as the notebook computer 1, the camcorder 2, the digital camera 3, the PDA 4, and the mobile phone 5 can be recognized by the remote control apparatus 10 to, for example, 5 m, 10 m, etc.

In addition, the remote control apparatus 10 further includes a controlled-device changing unit 16 which is connected to the CPU 11. The controlled-device changing unit 16 is used for selecting a device to be controlled when a plurality of devices are placed within the recognition range set by the recognition-range setting unit 15. A monitor 17 which will be described below is connected to the CPU 11, and the devices recognized by the remote control apparatus 10 are displayed on the monitor 17. A user views the monitor 17 and selects a device to be controlled with the controlled-device changing unit 16.

In FIG. 1, the monitor 17 is placed separately from the remote control apparatus 10, and information is communicated between the remote control apparatus 10 and the monitor 17 by wireless communication. In FIG. 2, however, the monitor 17 is shown as if it is included in the remote control apparatus 10 for convenience. When the monitor 17 is included in the remote control apparatus 10 as shown in FIG. 2, the monitor 17 is directly connected to the CPU 11.

As an example of a controller, the remote control apparatus 10 includes a rotation controller 18 which is connected to the CPU 11 and which is provided with a rotating wheel 19 for operation shown in FIG. 1. The rotation controller 18 performs various controls when the rotating wheel 19 is rotated. However, explanations of the rotation controller 18 are omitted since it is well known in the art and described in, for example, the above-described United States Patents. In the present embodiment, the operational feel of the rotating wheel 19 is set by the above-described software programs such that operational feel specific to the device being controlled can be obtained when the rotating wheel 19 is rotated.

In addition, as shown in FIG. 2, a printer 20 which communicates information with the remote control apparatus 10 by wireless communication is provided so that the information of the devices can be recorded and output by the printer 20.

The functions of the recognition-range setting unit 15 and the controlled-device changing unit 16 may also be performed by the rotation controller 18.

In addition, the wireless communication may be achieved by, for example, bluetooth, IEEE 802.11a/b, etc.

Next, the operation of the above-described remote control system according to the embodiment of the present invention will be described below.

When, for example, the notebook computer 1 is positioned within a predetermined range from the remote control apparatus 10 which is set in advance by the recognition-range setting unit 15, a signal transmitted from the notebook computer 1 is received by the receiver circuit 12 of the remote control apparatus 10 and is input to the CPU 11 from the receiver circuit 12. The CPU 11 recognizes that the controlled device is the notebook computer 1 on the basis of data stored in the memory 14, commands the monitor 17 to display a screen corresponding to the notebook computer 1, and sets the operational feel of the rotating wheel 19 to that corresponding to the notebook computer 1.

Then, the user operates the rotating wheel 19 of the rotation controller 18 to control the notebook computer 1 while viewing the screen corresponding to the notebook computer 1 which is displayed on the monitor 17. Accordingly, desired operations are performed. If it is necessary to output data, the CPU 11 outputs a control signal to the printer 20 and the data is output by the printer 20.

When, for example, the notebook computer 1 and the camcorder 2 are positioned within the predetermined range from the remote control apparatus 10 which is set in advance by the recognition-range setting unit 15, both the signal transmitted from the notebook computer 1 and a signal transmitted from the camcorder 2 are received by the receiver circuit 12 of the remote control apparatus 10 and are input to the CPU 11 from the receiver circuit 12. The CPU 11 determines that the recognized devices are the notebook computer 1 and the camcorder 2 on the basis of the data stored in the memory 14. The monitor 17 displays a screen showing that the recognized devices are the notebook computer 1 and the camcorder 2, and one of the notebook computer 1 and the camcorder 2 is selected as the controlled device by operating the controlled-device changing unit 16.

When, for example, the camcorder 2 is selected as the controlled device, the CPU 11 commands the monitor 17 to display a screen corresponding to the camcorder 2 and sets the operational feel of the rotating wheel 19 to that corresponding to the camcorder 2.

Then, the user operates the rotating wheel 19 of the rotation controller 18 to control the camcorder 2 while viewing the screen corresponding to the camcorder 2 which is displayed on the monitor 17. Accordingly, desired operations are performed. If it is necessary to output video data, the CPU 11 outputs a control signal to the monitor 17 and the video data is output via the remote control apparatus 10. If it is necessary to output still picture data, the CPU 11 outputs a control signal to the printer 20 and the still picture data is output by the printer 20.

As described above, in the remote control system according to the present embodiment, software programs for controlling various devices including the mobile devices are installed in the memory 14 of the remote control apparatus 10. Accordingly, a screen corresponding to each controlled device can be displayed on the monitor 17 simply by bringing the controlled device into the predetermined range from the remote control apparatus 10. Then, desired operations can be performed by operating the rotating wheel 19 of the rotation controller 18 with the operational feel specific to the controlled device.

Accordingly, an environment where the user can unconsciously use a ubiquitous network can be provided.

The present invention is not limited to the above-described embodiment, and various modifications are possible. For example, according to the present invention, the controlled devices are not limited to mobile devices, and other devices such as desktop computers capable of wireless communication may also be controlled. In addition, the system may of course be constructed such that the controlled devices communicate with each other by wireless communication.

In addition, although the rotation controller having the rotating wheel is used as a controller in the present embodiment, other kinds of controllers, such as a joystick, may also be used.

As described above, according to the present invention, a plurality of devices can be easily controlled.

More specifically, the remote control system includes a remote control apparatus which stores software programs for driving different kinds of devices capable of wireless communication and which recognizes the devices when the devices are positioned within a set range, and the remote control apparatus includes a monitor for displaying information of one or more of the devices which are being recognized and a controller for controlling the devices and the monitor. Accordingly, the remote control apparatus recognizes the devices when they are positioned within the set range and controls them using the software programs corresponding to the devices. Therefore, each of the devices can be easily controlled and an environment where a user can unconsciously use a ubiquitous network can be provided.

The remote control apparatus may further include a controlled-device selector for selecting a device to be controlled when two or more of the devices are recognized. In such a case, when two or more of the devices are simultaneously recognized by the remote control apparatus, a device to be controlled can be selected from among the recognized devices.

In addition, when the monitor is built-in in the remote control apparatus, the user can control the device while viewing the built-in monitor.

Alternatively, when the monitor is disposed separately from the remote control apparatus and information is communicated between the remote control apparatus and the monitor by wireless communication, the user can control the device while viewing the monitor disposed at a desired position.

In addition, when the remote control system further includes a printer for recording the information of the devices, the information of the devices can be recorded and output.

In addition, when the controller is controlled by a CPU such that the controller provides operational feel corresponding to the device being controlled, the corresponding device can be more easily controlled and the environment where the user can unconsciously use a ubiquitous network can be improved.

In addition, when the controller is a rotation controller having a rotating wheel for operation, a predetermined operation can be easily performed simply by rotating the rotating wheel.

What is claimed is:

1. A remote control system comprising:
a remote control apparatus which stores software programs for driving different kinds of devices capable of wireless communication and which recognizes the devices when the devices are positioned within a set range,
wherein the remote control apparatus includes a monitor for displaying information of one or more of the devices which are being recognized and a controller for controlling the devices and the monitor.

2. A remote control system according to claim 1, wherein the remote control apparatus further includes a controlled-device selector for selecting a device to be controlled when two or more of the devices are recognized.

3. A remote control system according to claim 1, wherein the monitor is built-in in the remote control apparatus.

4. A remote control system according to claim 2, wherein the monitor is built-in in the remote control apparatus.

5. A remote control system according to claim 1, wherein the monitor is disposed separately from the remote control apparatus, and
wherein information is communicated between the remote control apparatus and the monitor by wireless communication.

6. A remote control system according to claim 2, wherein the monitor is disposed separately from the remote control apparatus, and
wherein information is communicated between the remote control apparatus and the monitor by wireless communication.

7. A remote control system according to claim 1, further comprising a printer for recording the information of the devices.

8. A remote control system according to claim 1, wherein the controller is controlled by a CPU such that the controller provides operational feel corresponding to the device being controlled.

9. A remote control system according to claim 2, wherein the controller is controlled by a CPU such that the controller provides operational feel corresponding to the device being controlled.

10. A remote control system according to claim 3, wherein the controller is controlled by a CPU such that the controller provides operational feel corresponding to the device being controlled.

11. A remote control system according to claim 4, wherein the controller is controlled by a CPU such that the controller provides operational feel corresponding to the device being controlled.

12. A remote control system according to claim 5, wherein the controller is controlled by a CPU such that the controller provides operational feel corresponding to the device being controlled.

13. A remote control system according to claim 6, wherein the controller is controlled by a CPU such that the controller provides operational feel corresponding to the device being controlled.

14. A remote control system according to claim 7, wherein the controller is controlled by a CPU such that the controller provides operational feel corresponding to the device being controlled.

15. A remote control system according to claim 8, wherein the controller is a rotation controller having a rotating wheel for operation.

16. A remote control system according to claim 9, wherein the controller is a rotation controller having a rotating wheel for operation.

17. A remote control system according to claim 10, wherein the controller is a rotation controller having a rotating wheel for operation.

18. A remote control system according to claim 11, wherein the controller is a rotation controller having a rotating wheel for operation.

19. A remote control system according to claim 12, wherein the controller is a rotation controller having a rotating wheel for operation.

20. A remote control system according to claim 13, wherein the controller is a rotation controller having a rotating wheel for operation.
